(19) United States
(12) Patent Application Publication
(10) Pub. No.: US 2025/0113772 A1
(43) Pub. Date: Apr. 10, 2025

(54) MOWER BLADE FOR IMPROVED CUT QUALITY

(71) Applicant: ARIENS COMPANY, Brillion, WI (US)

(72) Inventors: Kevin A. SPATCHEK, Greenleaf, WI (US); Paul J. FERRIER, Sherwood, WI (US)

(21) Appl. No.: 18/835,682

(22) PCT Filed: Feb. 3, 2023
(86) PCT No.: PCT/US2023/061934

§ 371 Date: Aug. 2, 2024

Related U.S. Application Data
(60) Provisional application No. 63/306,864, filed on Feb. 4, 2022.

(51) Int. Cl. A01D 34/73; A01D 34/66; A01D 101/00

(52) U.S. Cl. CPC A01D 34/73; A01D 34/66; A01D 2101/00

(57) ABSTRACT

A cutting blade mounted to a lawn mower to cut vegetation under the lawn mower. The cutting blade configured to rotate relative to the mower deck in a rotational direction. The cutting blade including a first blade portion having a leading edge defining a primary cutting edge and a blade lift positioned behind the primary cutting edge along the rotational direction, and a second blade portion having a finishing cutting edge that is spaced from the blade lift along the rotational direction such that the blade lift is positioned between the primary cutting edge and the finishing cutting edge along the rotational direction.

### CROSS-REFERENCE TO RELATED APPLICATIONS

This application claims priority to U.S. Provisional Patent Application No. 63/306,864 filed on Feb. 4, 2022, the entire content of which is incorporated herein by reference.

### FIELD OF THE INVENTION

The present invention relates to a lawn mower blade that provides an improved cut quality.

### SUMMARY

In one aspect, the disclosure provides a lawn mower including a frame, a prime mover, a ground engaging element, a mower deck, and a cutting blade. The prime mover is supported by the frame. The ground engaging element supports the frame with respect to a ground surface and is rotatable under the influence of the prime mover to move the lawn mower over the ground surface. The mower deck is coupled to the frame. The cutting blade is mounted below the mower deck to cut vegetation under the mower deck. The cutting blade is configured to rotate relative to the mower deck in a rotational direction. The cutting blade includes a first blade portion and a second blade portion. The first blade portion has a leading edge defining a primary cutting edge and a blade lift positioned behind the primary cutting edge along the rotational direction. The second blade portion has a trailing cutting edge that is spaced from the blade lift along the rotation direction such that the blade lift is positioned between the primary cutting edge and the finishing cutting edge along the rotational direction.

In some aspects, the first blade portion and the second blade portion are formed integrally together as a single cutting blade.

In some aspects, the cutting blade is a cutting blade assembly having a first cutting blade that defines the first blade portion and a second cutting blade that defines the second blade portion. The first cutting blade and the second cutting blade are sequentially mounted to the lawn mower such that one of the first cutting blade and the second cutting blade are positioned directly on top of the other of the first cutting blade and the second cutting blade.

In some aspects, a first plane extends through both the primary cutting edge and the finishing cutting edge.

In some aspects, a first plane extends through the primary cutting edge, a second plane extends through the finishing cutting edge, and the first and second planes are vertically offset.

In some aspects, the first blade portion defines a plane that extends through the primary cutting edge, and the blade lift extends at an angle transverse to the plane.

In some aspects, the angle is between 10 and 45 degrees.

In some aspects, the primary cutting edge is a first primary cutting edge, the blade lift is a first blade lift, and the finishing cutting edge is a first finishing cutting edge. The cutting blade further includes a third blade portion and a fourth blade portion. The third blade portion having a second primary cutting edge and a second blade lift, the fourth blade portion having a second finishing cutting edge.

In some aspects, the lawn mower further includes a deck motor mounted to the cutting deck. The deck motor has an output spindle. The cutting blade is mounted to the output spindle such that the cutting blade is configured to be rotationally driven by the deck motor.

In some aspects, an angle is defined between the primary cutting edge and the finishing cutting edge. The angle is less than or equal to 90 degrees.

In another aspect, the disclosure provides a cutting blade mounted to a lawn mower to cut vegetation under the lawn mower. The cutting blade is configured to rotate relative to the lawn mower in a rotational direction. The cutting blade includes a first blade portion having a leading edge defines a primary cutting edge and a blade lift positioned behind the primary cutting edge along the rotational direction and a second blade portion having a finishing cutting edge that is spaced from the blade lift along the rotational direction such that the blade lift is positioned between the primary cutting edge and the finishing cutting edge along the rotational direction.

In some aspects, the first blade portion and the second blade portion are formed integrally together as a single cutting blade.

In some aspects, the cutting blade is a cutting blade assembly having a first cutting blade that defines the first blade portion and a second cutting blade that defines the second blade portion. The first cutting blade and the second cutting blade are sequentially mounted to the lawn mower such that one of the first cutting blade and the second cutting blade are positioned directly on top of the other of the first cutting blade and the second cutting blade.

In some aspects, the first blade portion defines a first plane that extends through the primary cutting edge. The second blade portion defines a second plane that extends through the finishing cutting edge. The first plane and the second plane are coplanar.

In some aspects, the first blade portion defines a first plane that extends through the primary cutting edge. The second blade portion defines a second plane that extends through the finishing cutting edge. The first plane and the second plane are parallel to and offset from each other.

In some aspects, the primary cutting edge is a first primary cutting edge, the blade lift is a first blade lift, and the finishing cutting edge is a first finishing cutting edge. The cutting blade further includes a third blade portion and a fourth blade portion. The third blade portion has a second leading edge defining a second primary cutting edge and a second blade lift. The fourth blade portion has a second finishing cutting edge.

In another aspect, the disclosure provides a lawn mower including a frame, a prime mover, a ground engaging element, a mower deck, and a cutting blade. The prime mover is supported by the frame. The ground engaging element supports the frame with respect to a ground surface and is rotatable under the influence of the motor to move the lawn mower over the ground surface. The mower deck is coupled to the frame. The cutting blade is mounted below the mower deck to cut vegetation under the mower deck. The cutting blade is configured to rotate relative to the mower deck in a rotational direction. The cutting blade includes a leading edge, a cutting edge spaced from the leading edge along the rotational direction, and a blade lift positioned between the leading edge and the cutting edge along the rotational direction. The blade lift is configured to induce an upward flow of air between the leading cutting edge and the trailing cutting edge.

In some aspects, the leading edge is a first leading edge, the blade lift is a first blade lift, and the cutting edge is a first cutting edge, the cutting blade further including a second leading edge, a second cutting edge spaced from the second leading edge along the rotational direction, and a second blade lift positioned between the second leading edge and the second cutting edge.

In some aspects, the cutting blade defines a plane that extends through the first leading edge and the second leading edge, and wherein each of the first blade lift and the second blade lift extends at an angle transverse to the plane.

Other aspects of the invention will become apparent by consideration of the detailed description and accompanying drawings.

### BRIEF DESCRIPTION OF THE DRAWINGS

FIG. 1 is a perspective view of a lawn mower according to an embodiment of the disclosure.

FIG. 2 is a perspective view of a cutting deck for the lawn mower of FIG. 1.

FIG. 3 is a perspective view of a cutting blade for the lawn mower of FIG. 1.

FIG. 4 is a top view of the cutting blade of FIG. 3.

FIG. 5 is a schematic view of the cutting blade of FIG. 3 illustrating airflow through the cutting blade.

FIG. 6 is a perspective view of a cutting blade according to another embodiment of the disclosure.

FIG. 7 is a schematic view of the cutting blade of FIG. 6.

FIG. 8 is a velocity graph for the cutting blade of FIG. 3.

FIG. 9 is a velocity graph for a prior art cutting blade.

### DETAILED DESCRIPTION

Before any embodiments of the invention are explained in detail, it is to be understood that the invention is not limited in its application to the detail of construction and the arrangement of components set forth in the following description or illustrated in the following drawings. The invention is capable of other embodiments and of being practiced or of being carried out in various ways.

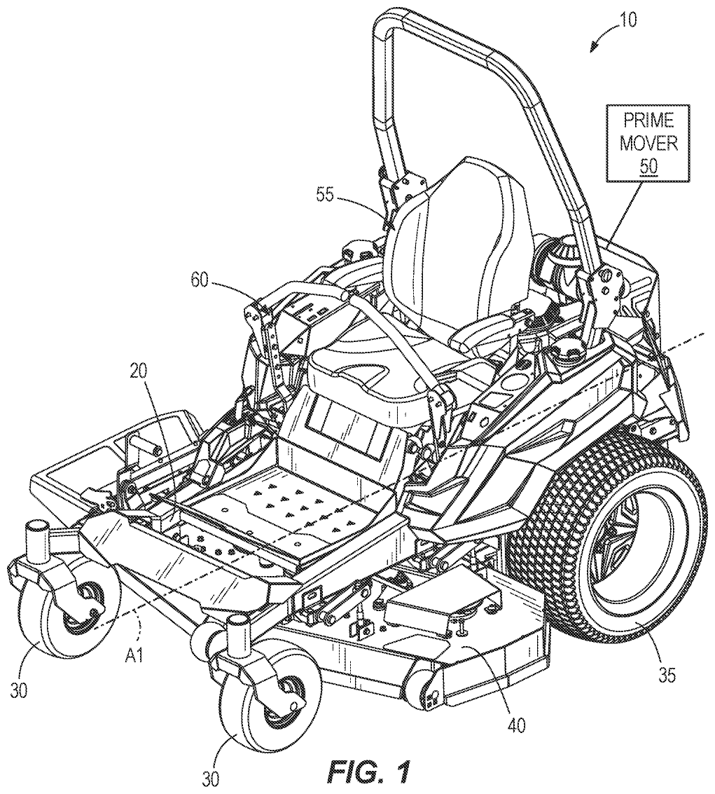

FIG. 1 illustrates an outdoor power equipment (OPE) vehicle in the form of a lawn mower 10. The lawn mower 10 is an electric mower in some embodiments. The lawn mower is a gas-powered lawn mower 10 in other embodiments. In the following description of the drawings, directional terms such as left, right, front, rear, up, down and the like are from the perspective of an operator in an ordinary operating position on the lawn mower during ordinary operation of the lawn mower 10.

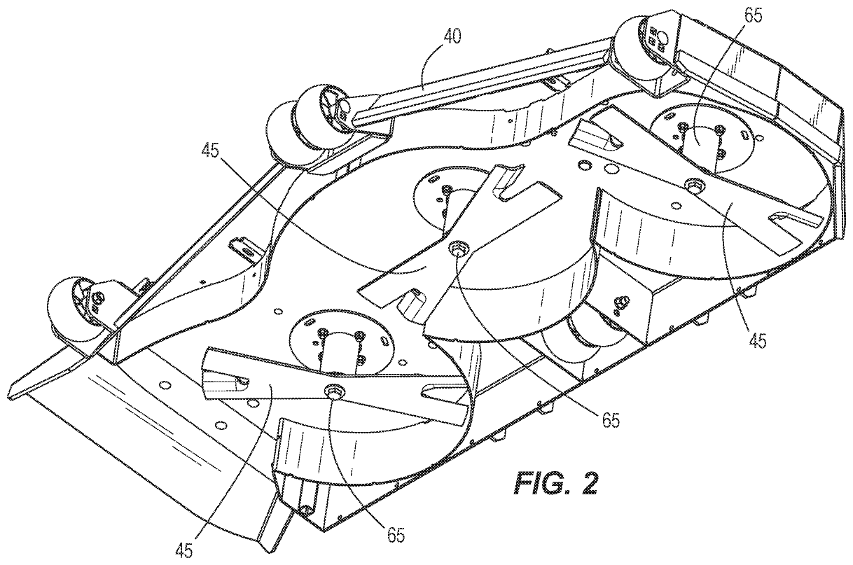

The lawn mower 10 includes a frame 20, front left and right caster wheels 30, rear left and right drive wheels 35, a cutting or mower deck 40, cutting blades 45 (FIG. 2), drive motors (not shown) configured to drive the rear left and right wheels 35, an operator platform 55 in the form of an operator seat, and a user interface 60. The mower 10 further includes a prime mover 50 configured to drive the wheels 35 and cutting deck 40. The prime mover 50 may be a motor, a battery, or the like.

As illustrated in FIG. 1, the frame 20 defines the basic body structure or chassis of the lawn mower 10 and supports the other components of the lawn mower 10. The frame 20 additionally defines a longitudinal axis A1 that extends centrally through the mower 10 from a rear end to a front end of the mower 10. The frame 20 is supported by the front left and right caster wheels 30 and the rear left and right drive wheels 35. The caster wheels 30 rotate passively as the lawn mower 10 moves over the ground and swivel about a vertical axis. The drive wheels 35 are driven to cause the lawn mower 10 to move and steer over the ground. In other embodiments, the caster wheels 30 and/or the drive wheels 35 are replaced with other ground-engaging elements, such as tracks. In other embodiments, the caster wheels 30 and drive wheels 35 are all driven wheels that move and steer the OPE vehicle by skid steering.

The drive wheels 35 are rotated by the drive motors 50 at a selected speed and direction, as dictated by user controls in the user interface 60, to effect movement and steering of the lawn mower 10 in the well-known manner of a zero turn radius lawn mower. In the illustrated embodiment, the lawn mower 10 is in the form of a stand-on mower, but in other embodiments the lawn mower 10 is configured in the style of a zero turn radius mower for a standing operator.

With reference to FIGS. 1 and 2, the cutting deck 40 is movably suspended from the frame 20, under the frame 20, such that the cutting deck 40 can be raised or lowered with respect to the frame 20 to adjust height of cut or put the cutting deck 40 in a relatively high position for transport. The cutting blades 45 are mounted to output spindles 65 below the cutting deck 40 to cut vegetation under the cutting deck 40 as the lawn mower 10 moves over the ground surface. In some embodiments, the lawn mower 10 includes deck motors positioned beneath the cutting deck 40 that drive rotation of the cutting blades 45. Specifically, the deck motors drive the output spindles 65. Each of the cutting blades 45 is mounted to a corresponding one of the output spindles 65 for rotation with the associated spindle 65, such that the cutting blades 45 are driven for rotation by the deck motors through the spindles 65. In other embodiments, the lawn mower 10 includes a cutting deck transmission assembly that drives rotation of the output spindles 65, and thus, drives rotation of the cutting blades 45.

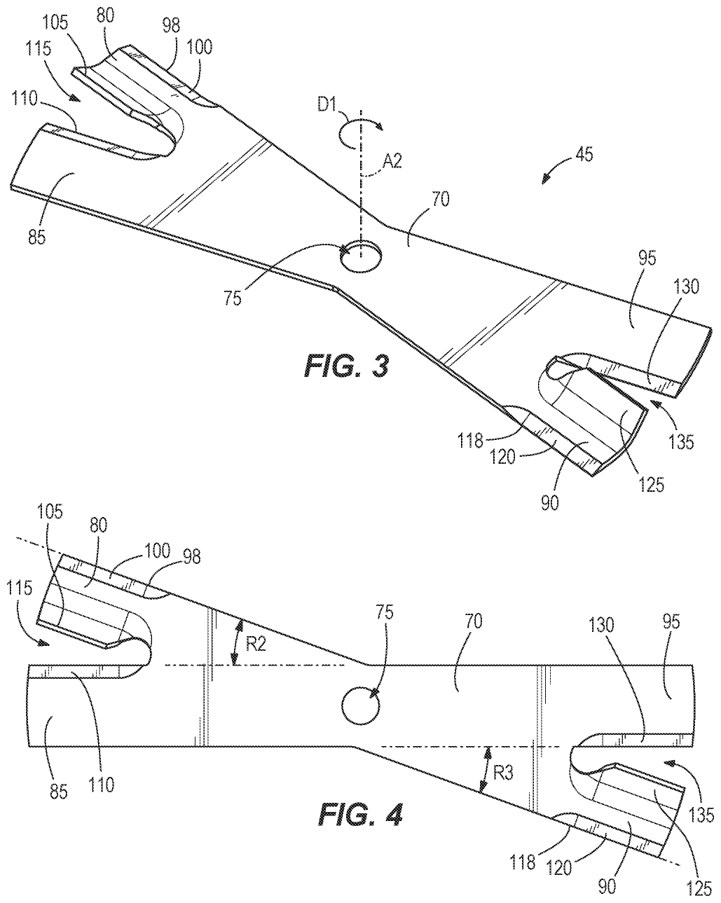

Although just a single cutting blade 45 is illustrated in FIG. 3, the description below applies equally to each cutting blade 45 illustrated in FIG. 2. The cutting blade 45 includes a body 70 having an aperture 75, a first blade portion 80, a second blade portion 85, a third blade portion 90, and a fourth blade portion 95. In the illustrated embodiment, the aperture 75 is defined in the center of the body 70 (i.e., the cutting blade 45 extends symmetrically to each side of the aperture 75). The aperture 75 receives the output spindle 65 (FIG. 2) to mount the cutting blade 45 for rotation with the output spindle 65 (FIG. 2). The aperture 75 defines a rotational axis A2, centered in the aperture 75, for the cutting blade 45. In other embodiments, the aperture 75 may not be centrally located on the body 70 such that the cutting blade 45 is configured to rotate eccentrically about the rotational axis A2. The cutting blade 45 may be secured to the output spindle 65 with a selectively removable fastener such as a washer or a bolt.

During operation of the lawn mower 10, the cutting blade 45 is configured to rotate relative to the cutting deck 40 in a rotational direction D1 about the rotational axis A2. In the illustrated embodiment, the rotational direction D1 is a clockwise direction from a perspective above the cutting blade 45 (counterclockwise from a perspective below the cutting blade 45). In the illustrated embodiment, the first blade portion 80 is identical to the third blade portion 90, and the second blade portion 85 is identical to the fourth blade portion 95.

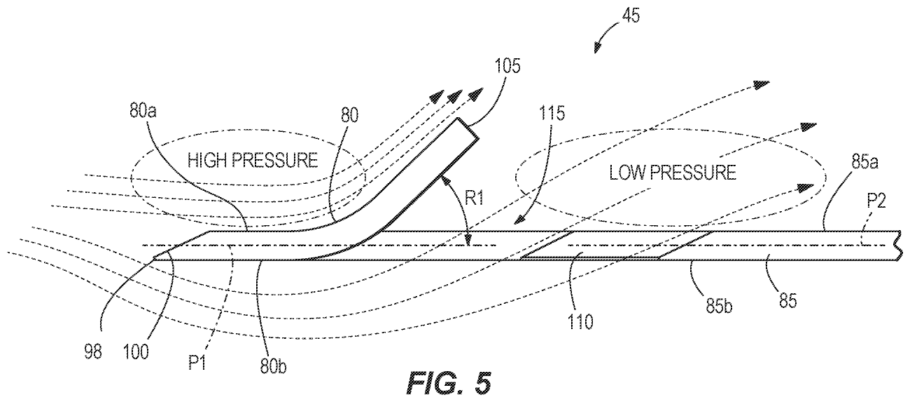

With reference to FIG. 5, the first blade portion 80 includes a top surface 80a, a bottom surface 80b, a leading edge 98 defining a primary cutting edge 100, and a blade lift 105. Both of the top surface 80a and the bottom surface 80b are planar and parallel with each other. As such, the first blade portion 80 defines a first plane P1 that is parallel to the top surface 80a and the bottom surface 80b and extends through the primary cutting edge 100. The first plane P1 may be defined at the top surface 80a, at the bottom surface 80b, or at any location between the top surface 80a and the bottom surface 80b. When the cutting blade 45 is mounted to the output spindle 65, the first plane P1 extends substantially parallel to a top surface of the cutting deck 40. The blade lift 105 is positioned behind the primary cutting edge 100 along the rotational direction D1, and can also be referred to as the trailing end of the first blade portion 80 (i.e., the end opposite the leading edge 98). The blade lift 105 is angled with respect to the primary cutting edge 100 by a lift angle R1 between 10 and 45 degrees.

With continued reference to FIG. 3-5, the second blade portion 85 includes a top surface 85a, a bottom surface 85b, and a trailing or finishing cutting edge 110. Both of the top surface 85a and the bottom surface 85b are planar and parallel with each other. As such, the second blade portion 85 defines a second plane P2 that is parallel to the top surface 85a and the bottom surface 85b and extends through the finishing cutting edge 110. The second plane P2 may be defined at the top surface 85a, at the bottom surface 85b, or at any location between the top surface 85a and the bottom surface 85b.

When the cutting blade 45 is mounted to the lawn mower 10, the first plane P1 is positioned a first distance from the cutting deck 40, and the second plane P2 is positioned a second distance from the cutting deck 40. In the illustrated embodiment, the first distance and the second distance are the same. Stated another way, the first plane P1 and the second plane P2 are coplanar.

The blade lift 105 is positioned between the primary cutting edge 100 and the finishing cutting edge 110. An aperture 115 is defined between the blade lift 105 and the finishing cutting edge 110. In the illustrated embodiment, the lift angle R1 is approximately equal to the finishing cutting edge 110. The aperture 115 creates a channel with parallel walls (e.g., formed by a rear portion of the blade lift 105 and the finishing cutting edge 110).

As illustrated in FIG. 4, the second blade portion 85 extends at a trailing angle R2 relative to the first blade portion 80. In particular, the trailing angle R2 is defined between the primary cutting edge 100 and the finishing cutting edge 110. In the illustrated embodiment, the trailing angle R2 between the first blade portion 80 and the second blade portion 85 is acute (e.g., 90 degrees or less). The trailing angle R2 between the first blade portion 80 and the second blade portion 85 may define the size of the aperture 115 if other features (e.g., width of first blade portion 80, configuration of blade lift 105) remain constant. As such, for a given configuration of the first blade portion 80, a relatively larger trailing angle R2 results in a relatively larger aperture 115, and a relatively smaller trailing angle R2 results in a relatively smaller aperture 115. The trailing angle R2 may be optimized for best cut quality for the cutting blade.

Returning reference to FIGS. 3-5, the third blade portion 90 includes a top surface that is coplanar with the top surface 80a of the first blade portion 80 and a bottom surface that is coplanar with the bottom surface 80b of the first blade portion 80. As disclosed above, the third blade portion 90 is radially symmetrical, and thus, effectively identical to the first blade portion 80. As such, the primary cutting edge 100 is a first primary cutting edge 100, and the blade lift 105 is a first blade lift 105 such that the third blade portion 90 includes a second leading edge 118 defining a primary cutting edge 120 and a second blade lift 125. The description of the first primary cutting edge 100 and the first blade lift 105 applies equally to the second primary cutting edge 120 and the second blade lift 125, respectively. As such, the first plane P1 extends through the second primary cutting edge 120. It should be appreciated that in other embodiments, the first and second leading edges 98, 118 may not define a primary cutting edge. In other words, the first and second leading edges may be blunt edges that do not cut grass. In such an embodiment, the finishing cutting edges 110, 130 would form the main cutting edge.

The fourth blade portion 95 includes a top surface that is coplanar with the top surface 85a of the second blade portion 85 and a bottom surface that is coplanar with the bottom surface 85b of the second blade portion 85. As disclosed above, the fourth blade portion 95 is radially symmetrical, and thus, effectively identical to the second blade portion 85. As such, the finishing cutting edge 110 is a first trailing cutting edge 110, and the aperture 115 is a first trailing aperture 115 such that the fourth blade portion 95 includes a second finishing cutting edge 130 and defines a second aperture 135. The description of the first trailing cutting edge 110 and the first aperture 115 applies equally to the second finishing cutting edge 130 and the second aperture 135, respectively. As such, the second plane P2 extends through the second finishing cutting edge 130.

The fourth blade portion 95 extends at a second trailing angle R3 relative to the third blade portion 90. In the illustrated embodiment, the first trailing angle R2 and he second trailing angle R3 are equal.

In the illustrated embodiment, the first blade portion 80, the second blade portion 85, the third blade portion 90, and the fourth blade portion 95 are formed integrally together. For example, the first blade portion 80, the second blade portion 85, the third blade portion 90, and the fourth blade portion 95 may be formed from a single metal casting process or another similar metal working process. As such, forming each of the blade portions 80, 85, 90, 95 may improve the ease of manufacturing of the cutting blade 45 and improve ease of assembly for the lawn mower 10.

During operation of the cutting blade 45, the cutting blade 45 is configured to create a pressure differential between the first blade portion 80 and the second blade portion 85. Although the third blade portion 90 and the fourth blade portion 95 are not illustrated in FIG. 5, description of the pressure differential between the first blade portion 80 and the second blade portion 85 applies equally to a pressure differential between the third blade portion 90 and the fourth blade portion 95. As it rotates, the cutting blade 45 causes a pressure differential in the air above the cutting blade 45 (e.g., between the cutting blade 45 and the top of the cutting deck 40 of FIG. 2). Specifically, the rotating first blade portion 80 causes higher pressure above it than the second blade portion 85. Thus, as it rotates the cutting blade 45 induces air to flow from below the cutting blade 45 up through the aperture 115 to the low pressure area above the second blade portion 85. The upward airflow lifts the grass on the ground surface below the cutting blade 45.

By providing blade lifts 105, 125 between the primary cutting edges 100, 120 and the finishing cutting edge 110, 130, the cutting blade 45 is enabled to induce airflow through the aperture 115, 135 that is strong enough to affect movement of the grass. Specifically, the cutting blade 45 may induce enough movement of the grass such that grass on the ground surface extends substantially parallel to the rotational axis A2. The finishing cutting edge 110, 130 may then cut the grass that was missed by the primary cutting edges 100, 120. As such, the positioning of the blade lifts 105, 125 between the primary cutting edges 100, 120 and the finishing cutting edge 110, 130 improves the quality of cut for the lawn mower 10. For example, the positioning of the blade lifts 105, 125 may improve the efficiency and the completeness with which the lawn mower may cut grass on the ground surface.

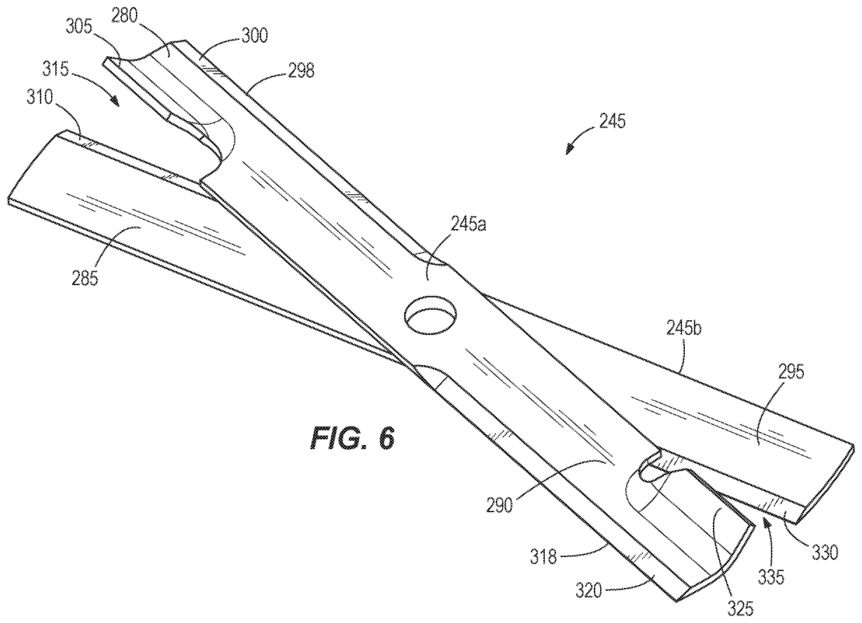

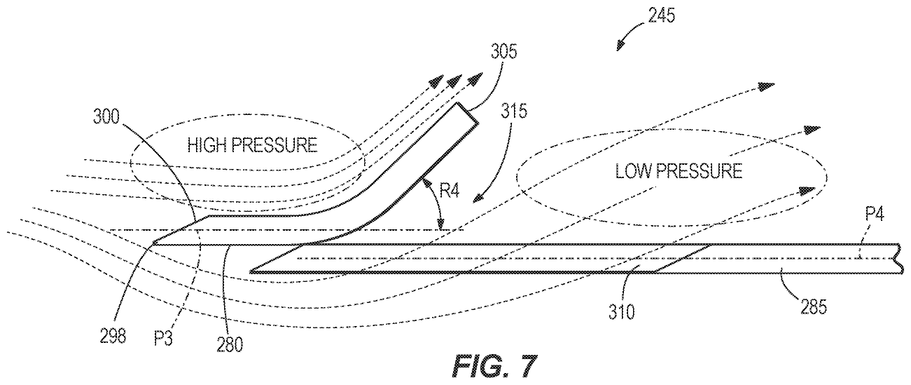

FIGS. 6 and 7 illustrate another embodiment of a cutting blade 245. The cutting blade 245 of FIGS. 6 and 7 is substantially similar to the cutting blade 45 of FIG. 3 except for the differences described herein. As illustrated in FIGS. 6 and 7, the cutting blade 245 includes a first blade portion 280, a second blade portion 285, a third blade portion 290, and a fourth blade portion 295. The first blade portion 280 includes a leading edge defining a primary cutting edge 300 and a first blade lift 305. The second blade portion 285 includes a first finishing cutting edge 310 and defines a first aperture 315 between the first blade lift 305 and the first finishing cutting edge 310. The second blade portion 285 extends at a trailing angle, such as the first trailing angle R2 (FIG. 4), relative to the first blade portion 280. The third blade portion 290 includes a second leading edge defining a second primary cutting edge 320 and a second blade lift 325. The fourth blade portion 295 includes a second finishing cutting edge 330 and defines a second aperture 335 between the second blade lift 325 and the second finishing cutting edge 330. The fourth blade portion 295 extends at a trailing angle, such as the second trailing angle R3 (FIG. 4), relative to the third blade portion 290. The first blade portion 280 and the third blade portion 290 define a first plane P3. The second blade portion 285 and the fourth blade portion 295 define a second plane P4. The first plane P3 and the second plane P4 are parallel to each other. Both of the first blade lift 305 and the second blade lift 325 extend from the first plane P3 at a lift angle R4 and in a direction away from the ground surface.

In the illustrated embodiment of the FIGS. 6 and 7, the cutting blade 245 is a cutting blade assembly having a first cutting blade 245a and a second cutting blade 245b. The first cutting blade 245a defines the first blade portion 280 and the third blade portion 290. The second cutting blade 245b defines the second blade portion 285 and the fourth blade portion 295. The first cutting blade 245a and the second cutting blade 245b are sequentially mounted to the lawn mower 10 (FIG. 1) such that one of the first cutting blade 245a and the second cutting blade 245b is positioned directly on top of the other of the first cutting blade 245a and the second cutting blade 245b. As such, the first blade portion 280 and the third blade portion 290 are formed separately from the second blade portion 285 and the fourth blade portion 295. Forming the blade portions 280, 285, 290, 295 separately may improve ease of maintenance and replacement for the cutting blade 245. For example, if one of the cutting edges 300, 310, 320, 330 gets damaged, each blade portion 280, 285, 290, 295 would not need to be replaced. Therefore, forming the blade portions 280, 285, 290, 295 separately may also reduce costs associated with usage wear on the cutting blade 245. When the cutting blade 245 is mounted to the lawn mower 10, the first plane P3 is positioned a first distance from the cutting deck 40, and the second plane P4 is positioned a second distance from the cutting deck 40. In the illustrated embodiment, the first distance is less than the second distance. As such, the first plane P3 and the second plane P4 are vertically offset from each other.

During operation of the cutting blade 245, the cutting blade 245 is configured to create a pressure differential between the first blade portion 280 and the second blade portion 285. Although the third blade portion 290 and the fourth blade portion 295 are not illustrated in FIG. 7, description of the pressure differential between the first blade portion 280 and the second blade portion 285 applies equally to a pressure differential between the third blade portion 290 and a fourth blade portion 295. As the cutting blade 245 rotates, a pressure differential forms in the ambient air above the cutting blade 245 (e.g., between the cutting blade 245 and the cutting deck 40 of FIG. 2). Specifically, the ambient air above the first blade portion 280 and the first leading cutting edge 300 has a relatively higher pressure than the ambient air above the second blade portion 285 and the trailing cutting edge 310. As such, as the cutting blade 245 rotates, the high pressure above the first blade portion 280 induces air to flow below cutting blade 245. The air then flows through the trailing aperture 315 to the low pressure ambient air above the second blade portion 285. As the air flows below the cutting blade 245 and through the trailing aperture 315, the air affects an upward movement of grass on the ground surface.

By providing blade lifts 305, 325 between the leading cutting edges 300, 320 and the trailing cutting edges 310, 330, the cutting blade 245 is enabled to induce airflow through the trailing apertures 315, 335 that is strong enough to affect movement of the grass. Specifically, the cutting blade 245 may induce enough movement of the grass such that grass on the ground surface extends substantially parallel to the rotational axis A2. The trailing cutting edges 310, 330 may then cut any grass that was missed by the leading cutting edges 300, 320. As such, the positioning of the blade lifts 305, 325 improves the quality of cut for the lawn mower 10. For example, the positioning of the blade lifts 305, 325 may improve the efficiency and the completeness with which the lawn mower 10 (FIG. 1) may cut grass on the ground surface.

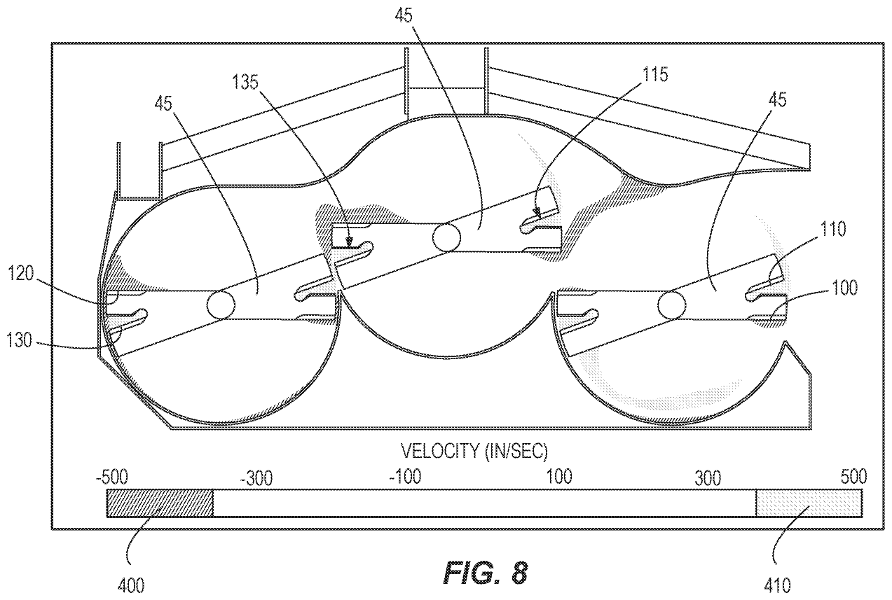

FIG. 8 illustrates a velocity graph for the cutting blades 45 during rotation of the cutting blades 45. Although a velocity graph for the cutting blade 245 of FIG. 6 is not illustrated, the velocity graph for the cutting blade 45 is substantially similar to the velocity graph for the cutting blade 245 of FIG. 6. The graph illustrates velocity of air flow in a direction perpendicular to the first plane P1 and the second plane P2 of FIG. 5. As illustrated by the scale in FIG. 8, portions of the graph that are sectioned with solid lines (e.g. depicted as 400 in the scale of the graph) illustrate areas where the cutting blade 45 induces a downward flow of air (i.e., toward the ground surface), and portions of the graph that are sectioned with dashed lines (e.g., depicted as 410 in the scale of the graph) illustrate areas where the cutting blade 45 induces an upward flow of air (i.e., away from the ground surface). As illustrated by the portions of the graph sectioned with dashed lines in FIG. 8, during operation of the cutting blade 45, the cutting blade 45 induces an upward flow of air through the aperture 115, 135 between the primary cutting edges 100, 120 and the finishing cutting edge 110, 130. As described above, the upward velocity of the airflow affects movement of grass on the ground surface to enable a better grass cut.

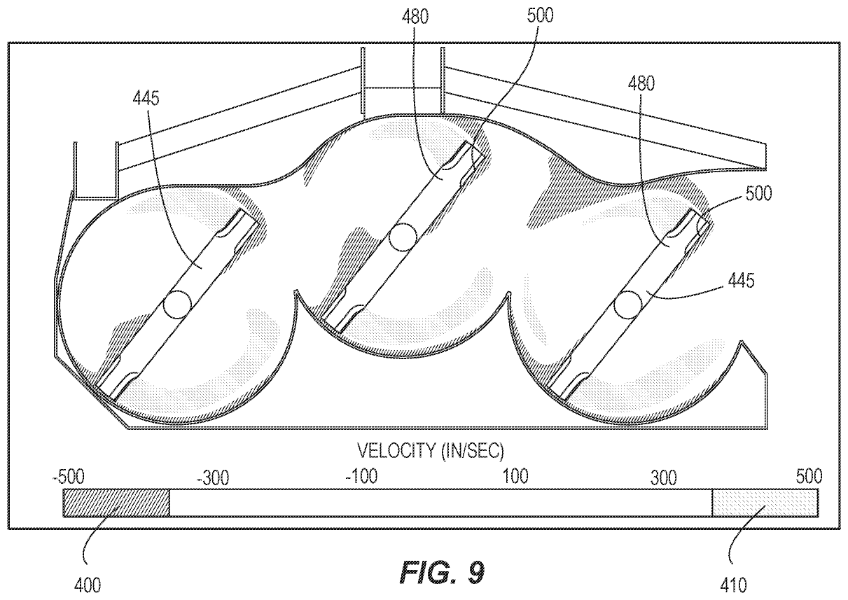

FIG. 9 illustrates a velocity graph for a prior art cutting blade 445. The velocity graph follows the same color shading scale as the graph of FIG. 8. The prior art cutting blade 445 includes a blade portion 480 having a leading cutting edge 500. As illustrated in the graph, the prior art cutting blade 445 induces a downward flow of air (i.e., solid line region) in front of the leading cutting edge 500 and induces an upward flow of air behind the blade portion 480. The prior art does not have a trailing cutting edge and a trailing aperture, and thus, does not cut grass on the ground surface that has been affected by an upward flow of air induced by the cutting blade 445. Rather, the cutting blade 445 may only cut grass that has not been affected by a downward flow of air. As such, prior art cutting blades 445 are not able to cut with the same efficiency and completeness as the cutting blade 45 of FIG. 3 or the cutting blade 245 of FIG. 6.

Various features and advantage of the invention are set forth in the following claims.

1. A lawn mower comprising:
a frame;
a prime mover supported by the frame;
a ground engaging element supporting the frame with respect to a ground surface and rotatable under the influence of the prime mover to move the lawn mower over the ground surface;
a mower deck coupled to the frame; and
a cutting blade mounted below the mower deck to cut vegetation under the mower deck, the cutting blade configured to rotate relative to the mower deck in a rotational direction, the cutting blade including
a first blade portion having a leading edge defining a primary cutting edge and a blade lift positioned behind the primary cutting edge along the rotational direction, and
a second blade portion having a finishing cutting edge that is spaced from the blade lift along the rotational direction such that the blade lift is positioned between the primary cutting edge and the finishing cutting edge along the rotational direction.

2. The lawn mower of claim 1, wherein the first blade portion and the second blade portion are formed integrally together as a single cutting blade.

3. The lawn mower of claim 1, wherein the cutting blade is a cutting blade assembly having a first cutting blade defining the first blade portion and a second cutting blade defining the second blade portion, wherein the first cutting blade and the second cutting blade are sequentially mounted to the lawn mower such that one of the first cutting blade and the second cutting blade are positioned directly on top of the other of the first cutting blade and the second cutting blade.

4. The lawn mower of claim 1, wherein a first plane extends through both the primary cutting edge and the finishing cutting edge.

5. The lawn mower of claim 1, wherein
a first plane extends through the primary cutting edge,
a second plane extends through the finishing cutting edge, and
the first and second planes are vertically offset.

6. The lawn mower of claim 1, wherein the first blade portion defines a plane that extends through the primary cutting edge, and wherein the blade lift extends at an angle transverse to the plane.

7. The lawn mower of claim 6, wherein the angle is between 10 and 45 degrees.

8. The lawn mower of claim 1, wherein the primary cutting edge is a first primary cutting edge, the blade lift is a first blade lift, and the finishing cutting edge is a first finishing cutting edge, and
wherein the cutting blade further includes a third blade portion and a fourth blade portion, the third blade portion having a second primary cutting edge and a second blade lift, the fourth blade portion having a second finishing cutting edge.

9. The lawn mower of claim 1, further comprising a deck motor mounted to the cutting deck, the deck motor having an output spindle, and wherein the cutting blade is mounted to the output spindle such that the cutting blade is configured to be rotationally driven by the deck motor.

10. The lawn mower of claim 1, wherein an angle is defined between the primary cutting edge and the finishing cutting edge, and wherein the angle is less than or equal to 90 degrees.

11. A cutting blade mounted to a lawn mower to cut vegetation under the lawn mower, the cutting blade configured to rotate relative to the lawn mower in a rotational direction, the cutting blade comprising:
a first blade portion having a leading edge defines a primary cutting edge and a blade lift positioned behind the primary cutting edge along the rotational direction; and
a second blade portion having a finishing cutting edge that is spaced from the blade lift along the rotational direction such that the blade lift is positioned between the primary cutting edge and the finishing cutting edge along the rotational direction.

12. The cutting blade of claim 11, wherein the first blade portion and the second blade portion are formed integrally together as a single cutting blade.

13. The lawn mower of claim 11, wherein the cutting blade is a cutting blade assembly having a first cutting blade defining the first blade portion and a second cutting blade defining the second blade portion, wherein the first cutting blade and the second cutting blade are sequentially mounted to the lawn mower such that one of the first cutting blade and the second cutting blade are positioned directly on top of the other of the first cutting blade and the second cutting blade.

14. The cutting blade of claim 11, wherein the first blade portion defines a first plane that extends through the primary cutting edge, wherein the second blade portion defines a second plane that extends through the finishing cutting edge,

15. The cutting blade of claim 14, wherein the first plane and the second plane are coplanar.

16. The cutting blade of claim 14, wherein the first plane and the second plane are parallel to and offset from each other.

17. The cutting blade of claim 11, wherein the primary cutting edge is a first primary cutting edge, the blade lift is a first blade lift, and the finishing cutting edge is a first finishing cutting edge, and
wherein the cutting blade further includes a third blade portion and a fourth blade portion, the third blade portion having a second leading edge defining a second primary cutting edge and a second blade lift, the fourth blade portion having a second finishing cutting edge.

18. A lawn mower comprising:
a frame;
a prime mover supported by the frame;
a ground engaging element supporting the frame with respect to a ground surface and rotatable under the influence of the motor to move the lawn mower over the ground surface;
a mower deck coupled to the frame; and
a cutting blade mounted below the mower deck to cut vegetation under the mower deck, the cutting blade configured to rotate relative to the mower deck in a rotational direction, the cutting blade including a leading edge, a cutting edge spaced from the leading edge along the rotational direction, and a blade lift positioned between the leading edge and the cutting edge along the rotational direction;
wherein the blade lift is configured to induce an upward flow of air between the leading edge and the cutting edge.

19. The lawn mower of claim 18, wherein the leading edge is a first leading edge, the blade lift is a first blade lift, and the cutting edge is a first cutting edge, the cutting blade further including a second leading edge, a second cutting edge spaced from the second leading edge along the rotational direction, and a second blade lift positioned between the second leading edge and the second cutting edge.

20. The lawn mower of claim 19, wherein the cutting blade defines a plane that extends through the first leading edge and the second leading edge, and wherein each of the first blade lift and the second blade lift extends at an angle transverse to the plane.
